(19) United States
(12) Patent Application Publication
(10) Pub. No.: US 2026/0003636 A1
(43) Pub. Date: Jan. 1, 2026

(54) PROCESS-AWARE BOOT-UP

(71) Applicant: QUALCOMM Incorporated, San Diego, CA (US)

(72) Inventors: Pragya PANDE, Lucknow (IN); Rohit SINGH, Hyderabad (IN); Vandit CHAUHAN, Hyderabad (IN); Amit GARG, Hyderabad (IN); Udit BANSAL, Hyderabad (IN); Yashaswini N, Sakaleshpur (IN)

(21) Appl. No.: 18/755,469

(22) Filed: Jun. 26, 2024

(51) Int. Cl. G06F 9/4401; G06F 1/28

(52) U.S. Cl. CPC G06F 9/4401; G06F 1/28

(57) ABSTRACT

This disclosure provides methods, components, devices and systems for process-aware boot-up. An example method, performed at a system-on-a-chip (SoC), generally includes obtaining parameters associated with estimated boot-up power consumption for different parts of the SoC, and setting at least one of operating voltages or operating frequencies for the different parts during a boot-up procedure, based on the corresponding parameters.

### TECHNICAL FIELD

This disclosure relates generally to system-on-chip devices (e.g., wireless communication devices), and more specifically, to process-aware boot-up.

### DESCRIPTION OF THE RELATED TECHNOLOGY

Wireless communication networks, such as 5G new radio (NR), may provide a high-speed, low-latency and high-reliability wireless connectivity which can enable immersive virtual reality (VR), augmented reality (AR) and extended reality (XR) multimedia and cloud computing services. XR/multimedia data services may involve various user interface (UI) devices, such as AR Glasses and VR Head-Mounted Displays (HMDs) used in Cloud-based Gaming and Cloud-based artificial intelligence (AI). These advanced multimedia applications may have strict system requirements. Requirements include high data rate and low latency to better allow a targeted 99% of XR traffic to be delivered within a packet delay budget (PDB) (e.g., 10 ms).

Power utilization, thermal output, and processing time generally scale with computational complexity. That is, less computationally complex operations generally consume less power and are completed more quickly than more computationally complex operations. Consequently, the execution of more computationally complex operations, such as those related to XR applications, may result in increased thermal output, reduced battery life, and delays in the ability to reassign computing resources (e.g., compute cores on a processor, memory, etc.) to other tasks executing on a device.

### SUMMARY

The systems, methods and devices of this disclosure each have several innovative aspects, no single one of which is solely responsible for the desirable attributes disclosed herein.

One innovative aspect of the subject matter described in this disclosure can be implemented in a system-on-chip (SoC), a wireless node, or a wireless communication device. The SoC/wireless node/or wireless communication device includes means for obtaining parameters associated with estimated boot-up power consumption for different parts of the SoC; and means for setting at least one of operating voltages or operating frequencies for the different parts during a boot-up procedure, based on the corresponding parameters.

One innovative aspect of the subject matter described in this disclosure can be implemented in a method performed at a system-on-a-chip (SoC). The method includes obtaining parameters associated with estimated boot-up power consumption for different parts of the SoC; and setting at least one of operating voltages or operating frequencies for the different parts during a boot-up procedure, based on the corresponding parameters.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a block diagram illustrating an example system-on-a-chip (SoC) and a Power Management Integrated Circuit (PMIC).

FIG. 3 shows a process flow diagram illustrating techniques for process-aware boot-up, in accordance with aspects of the present disclosure.

FIG. 4 shows a graph illustrating metrics associated with various regions of an SoC, in accordance with aspects of the present disclosure.

FIG. 5 shows a flowchart illustrating an example process performable by or at a wireless system-on-a-chip (SoC) that supports process-aware boot-up.

FIG. 6 shows a block diagram of an example wireless communication device that supports process-aware boot-up.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of performing operations described herein.

The current form factor of extended reality (XR) (e.g., including Augmented Reality, Mixed Reality and Virtual Reality) devices presents unique challenges to be addressed for optimal user comfort. For example, XR devices are generally worn directly on the user's head or face, leading to close contact with the skin. Power-intensive computational tasks generate heat, which could accumulate within the device and affect user comfort. One such critical power-intensive use-case is when the device boots-up, which can lead to skin temperature/heat management concerns.

The CPU is a major power consumer (e.g., about 50% of SoC power consumption) in such use cases, and the power consumption and temperature concerns described above are even more significant for higher-leakage parts towards the end of the process distribution.

In conventional systems, device boot-up includes static voting for all SoC rails. In other words, the same SoC vote (e.g., voted corners) are employed for all parts across the process distribution. However, power consumption scales up with part leakage, and the higher-leakage parts (e.g., towards the end of the process distribution) boot up with relatively higher power consumption (with the same SoC vote), resulting in relatively higher increase in the temperature of the portion of the device in contact with a user's skin (which may be referred to as the device skin temperature).

Aspects of the present disclosure, however, provide mechanisms that may help control device temperature, particular during boot-up. The mechanisms may be referred to as part-based process-aware boot-up. Certain techniques disclosed herein may consider a parts open loop (OL) voltage and quiescent current (IDDq) fuses as inputs at boot-time, and may evaluate the power-range of the part (e.g., using equations identified in an offline analysis) and use a look-up table (LUT) to map the power-range to the appropriate CPU vote.

Utilization of the techniques disclosed herein may result in lower power consumption (and a reduced subsequent increase in skin temperature) during device boot-up by employing a CPU vote-selection framework (e.g., based on part/process leakage and part Vₘᵢₙ). The mitigation of power consumption and skin temperature issues may be especially pronounced for parts in the higher-power range.

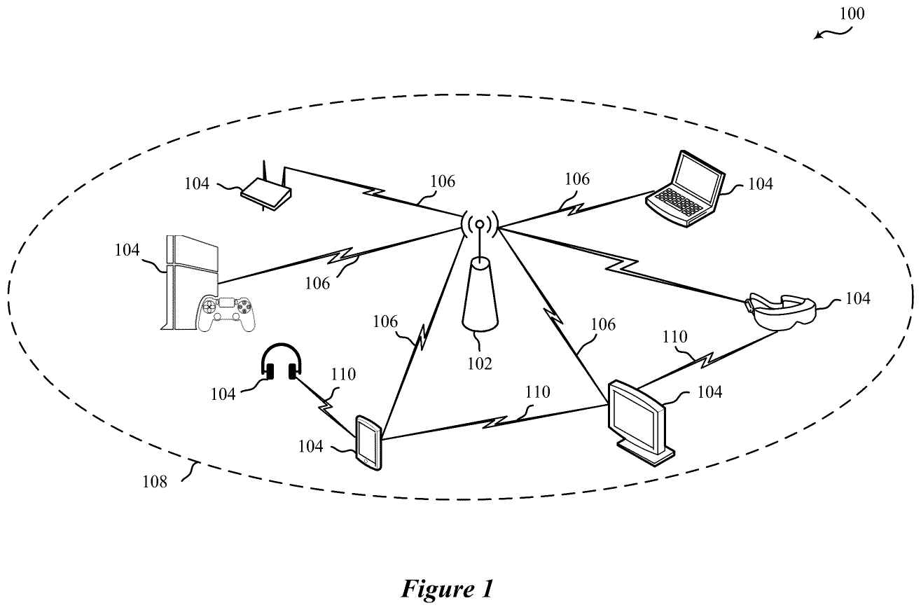

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

### Example Aspects Related to Process-Aware Boot-Up for Temperature Mitigation

As noted above, the current form factor of extended reality (XR) (e.g., including Augmented Reality, Mixed Reality and Virtual Reality) devices presents unique challenges to be addressed for optimal user comfort. For example, XR devices are generally worn directly on the user's head or face, leading to close contact with the skin.

Power-intensive computational tasks generate heat, which could accumulate within the device and affect user comfort. One such critical power-intensive use-case is when the device boots-up, which can lead to skin temperature/heat management concerns.

In conventional systems, device boot-up includes static voting for all SoC rails. In other words, the same SoC vote (e.g., voted corners) are employed for all parts across the process distribution. However, power consumption scales up with part leakage, and the higher-leakage parts (e.g., towards the end of the process distribution) boot up with relatively higher power consumption (with the same SoC vote), resulting in relatively higher increase in the skin temperature of the device.

Aspects of the present disclosure, however, provide techniques for part-based process-aware boot-up and CPU/SoC voting. Certain techniques disclosed herein may consider a parts open loop (OL) voltage and quiescent current (IDDq) fuses as inputs at boot-time, and may evaluate the power-range of the part (e.g., using equations identified in an offline analysis) and use a look-up table to map the power-range to the appropriate CPU vote.

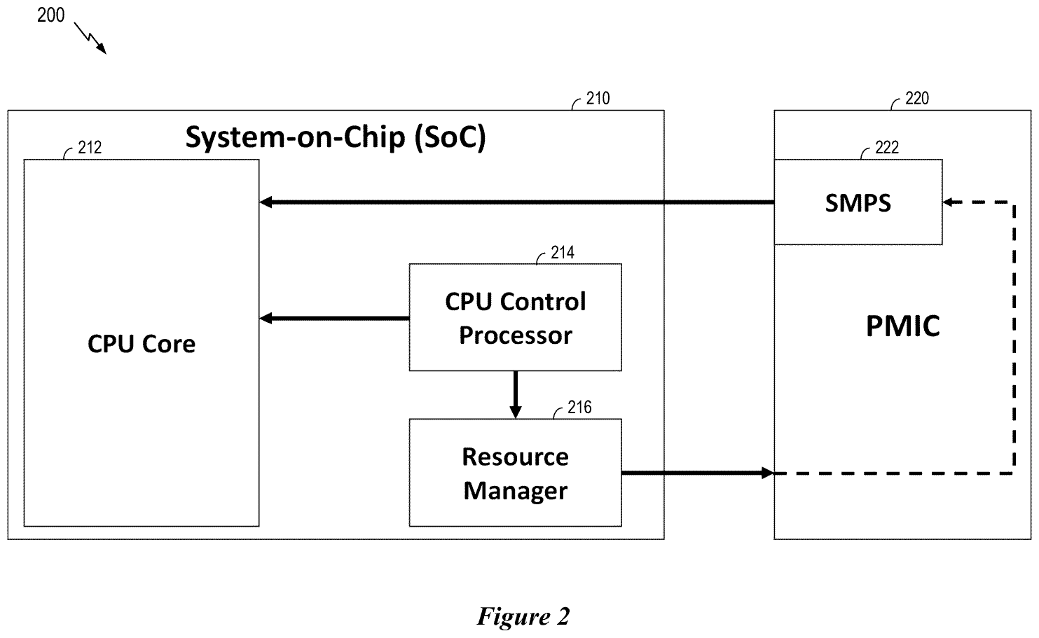

FIG. 2 shows a block diagram 200 for an example use case in which aspects of the present disclosure may be utilized.

The example includes a system-on-a-chip (SoC) 210 and a Power Management Integrated Circuit (PMIC) 220. As illustrated, the SoC 210 may include at least one CPU core 212, at least one CPU control processor 214, and a resource manager 216, and may be coupled to/associated with a PMIC 220, which may include a Switched-Mode Power Supply (SMPS) 222.

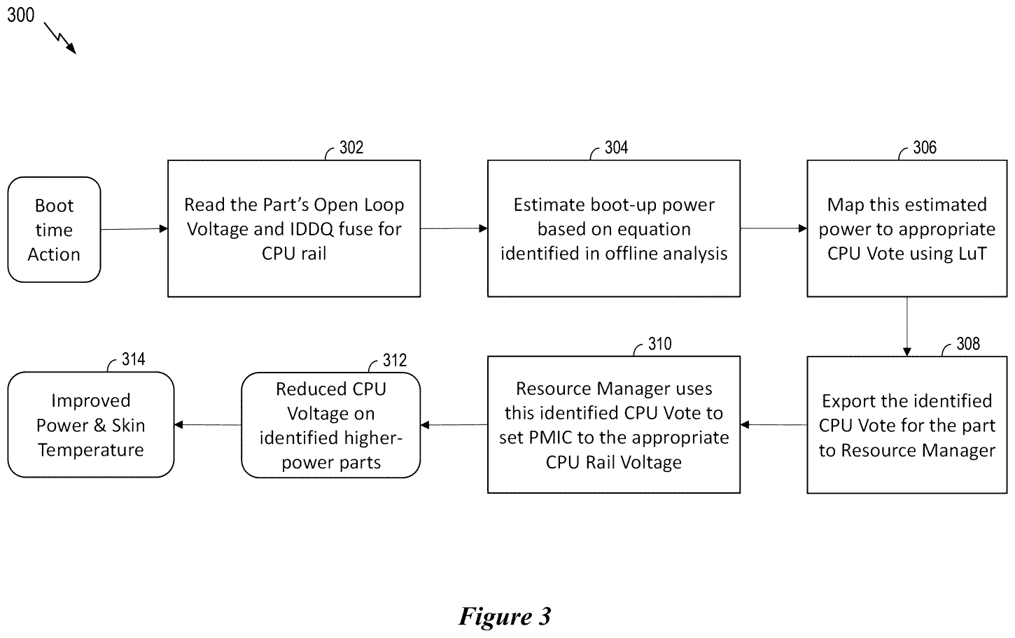

FIG. 3 shows a process flow diagram 300 illustrating techniques for process-aware boot-up to mitigate temperature, in accordance with aspects of the present disclosure.

As illustrated at 302, the SoC (e.g., or a component/part of the SoC) may read (e.g., obtain), an Open Loop Voltage (OL) and a Quiescent Current (IDDQ) fuse (e.g., for a CPU rail) for one or more parts.

As illustrated at 304, the SoC (e.g., or a component/part of the SoC) may estimate a boot-up power (e.g., of the one or more parts) based on one or more equations (e.g., which may be (pre)identified in an offline analysis). An example equation for determining the boot-up power for a part is:

$${Power}_{CPU , Part} ( mW ) = [ ( {Dynamic}_{ReferenceTT} ( mW ) \times {( \frac{{V}_{CPU , Part}}{{V}_{CPU , ReferenceTT}} )}^{2} ) + ( {Leakage}_{ReferenceTT} ( mW ) \times {( \frac{{V}_{CPU , Part}}{{V}_{CPU , ReferenceTT}} )}^{2} ) \times \frac{{IDDq}_{CPU , Part}}{{IDDq}_{CPU , ReferenceTT}} ] ,$$

where TT refers to a Typical-Typical (Part Split).

As illustrated at 306, the estimated power(s) may be mapped to an appropriate CPU vote. For example, that mapping may be performed using a lookup table (LUT) that maps estimated power(s) to one of a set of different CPU vote types (e.g., Turbo, Nom_L1, Nom, SVS_L1, SVS) which may correspond to different voltage and clock settings.

As illustrated at 308, the identified CPU vote (e.g., for each part) may be exported to a resource manager component of the SoC. As illustrated at 310, the resource manager may use the CPU vote(s) to set the Power Management Integrated Circuit (PMIC) 220 to an appropriate CPU rail voltage (e.g., which may be associated with/mapped to the CPU vote).

As illustrated at 312 and 314, these techniques may allow for reduced CPU voltage on parts of the SoC that have been identified as higher power parts, leading to improved power and temperature metrics (e.g., reduced skin temperature for users).

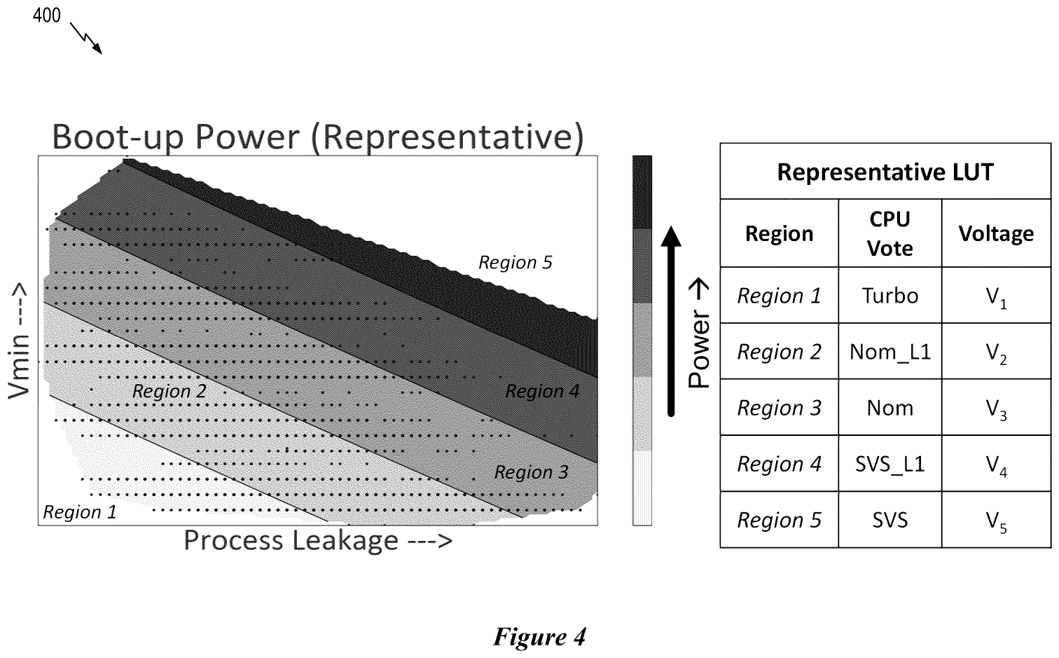

FIG. 4 shows a graph 400 illustrating metrics associated with various regions of an SoC, in accordance with aspects of the present disclosure.

As illustrated, after considering the open loop (OL) voltage and quiescent current (IDDq) fuses for a given part as inputs at boot-time, and after evaluation of the power-range of each part (e.g., using equations identified in an offline analysis), a look-up table (LUT) may be used to map the power-range to the appropriate CPU vote (e.g., which may be associated with a voltage). As described above, the vote values may be provided/outputted to a resource manager (e.g., a component of the SoC).

As illustrated, in some cases, the SoC may be partitioned into regions based on certain metrics (e.g., the power or power-range of each part). In the illustrated example, the SoC is partitioned into five regions (e.g., Regions 1-5). The parts (and the corresponding CPU votes) may be grouped by regions (e.g., each region including one or more parts). The appropriate region for a part can be identified during boot-time by comparing with line equations (e.g., y+mᵢx<cᵢ).

As noted above, utilization of the techniques disclosed herein may result in lower power consumption (and a reduced subsequent increase in skin temperature) during device boot-up by employing a CPU vote-selection framework (e.g., based on part/process leakage and a part's Vₘᵢₙ (a Minimum Settling Voltage for a part)). The mitigation of power consumption and skin temperature issues may be especially pronounced for parts in the higher-power range.

### Example Method

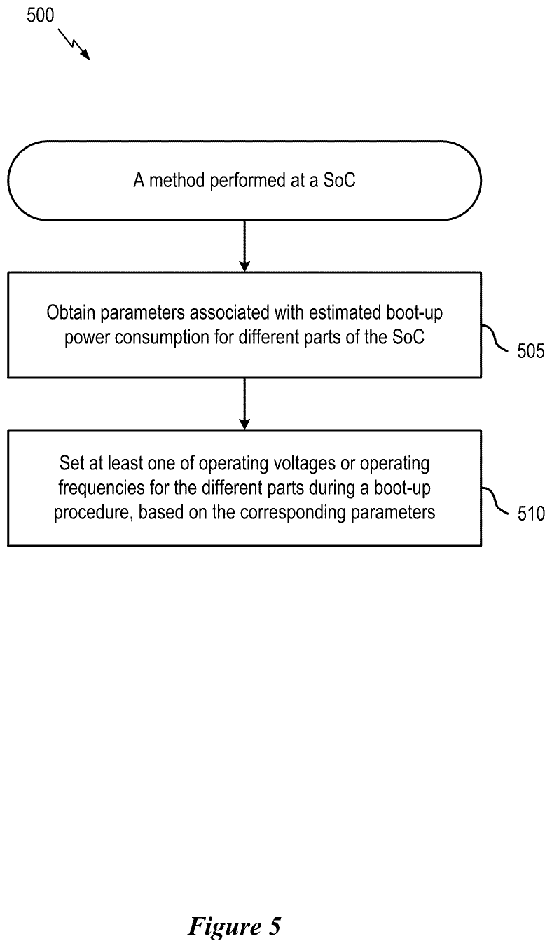

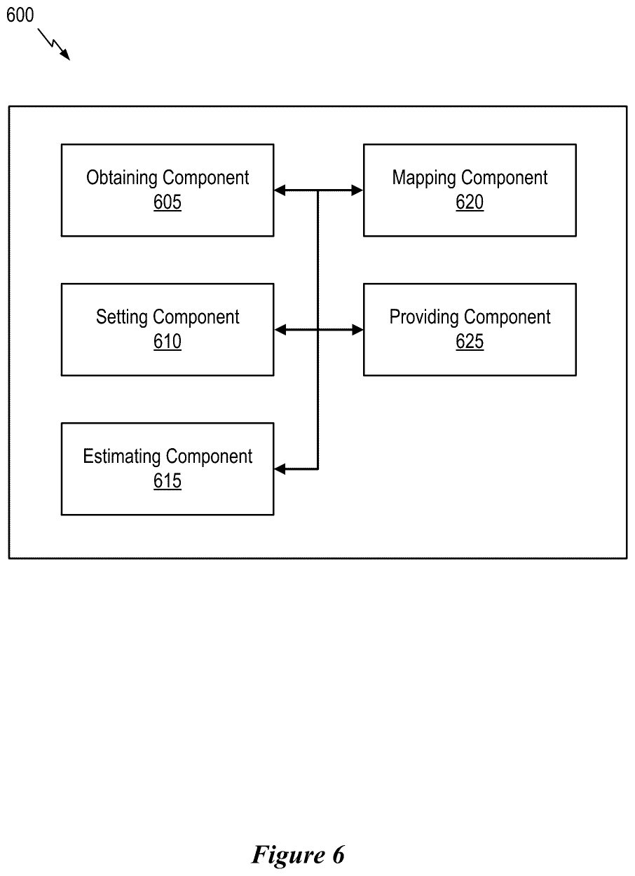

FIG. 5 shows a flowchart illustrating an example process 500 performable by or at a SoC that supports process-aware boot-up. The operations of the process 500 may be implemented by a wireless AP, or its components as described herein, and/or a wireless STA, or its components as described herein. For example, the process 500 may be performed by a wireless communication device, such as the wireless communication device 600 described with reference to FIG. 6, operating as or within a wireless AP and/or a wireless STA. In some examples, the process 500 may be performed by a wireless AP such as one of the APs 102 described with reference to FIG. 1. In some examples, the process 500 may be performed by a wireless STA such as one of the STAs 104 described with reference to FIG. 1.

In some examples, in block 505, the SoC may obtain parameters associated with estimated boot-up power consumption for different parts of the SoC. In some cases, the operations of this step refer to, or may be performed by, an obtaining component as described with reference to FIG. 6.

In some examples, in block 510, the SoC may set at least one of operating voltages or operating frequencies for the different parts during a boot-up procedure, based on the corresponding parameters. In some cases, the operations of this step refer to, or may be performed by, a setting component as described with reference to FIG. 6.

In some examples, the parameters comprise at least one of open loop voltage or leakage current for the different parts.

In some examples, the process 500 further includes estimating the boot-up power consumptions for the different parts based on the open loop voltages and the leakage currents obtained for the different parts. In some cases, the operations of this step refer to, or may be performed by, an estimating component as described with reference to FIG. 6.

In some examples, setting at least one of operating voltages or operating frequencies for the different parts during a boot-up procedure comprises: mapping the estimated boot-up power consumptions to values; and providing the values to a resource manager component that sets the operating voltages and operating frequencies for the different parts during the boot-up procedure.

In some examples, the values correspond to regions, each region defined by a range of boot-up power consumption.

In some examples, mapping the estimated boot-up power consumptions to values comprises: for each different part, mapping the estimated boot-up power consumption for that part to one of the regions.

In some examples, each region has a corresponding vote value; and providing the values to the resource manager component comprises providing the vote values to the resource manager component.

Note that FIG. 5 is just one example of a method, and other methods including fewer, additional, or alternative steps are possible consistent with this disclosure.

FIG. 6 shows a block diagram of an example wireless communication device 600 that supports process-aware boot-up. In some examples, the wireless communication device 600 is configured to perform the process 500 described with reference to FIG. 5. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 600 may transmit the information output from the chip. In such an example, the second interface may refer to an interface between the processing system of the chip and a reception component, such that the device 600 may receive information that is passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP, such as the AP 102 described with reference to FIG. 1. In some other examples, the wireless communication device 600 can be an AP that includes such a processing system and other components including multiple antennas. In some examples, the wireless communication device 600 can be configurable or configured for use in a STA, such as the STA 104 described with reference to FIG. 1. In some other examples, the wireless communication device 600 can be a STA that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet. In some examples, the wireless communication device 600 further includes a user interface (UI) (such as a touchscreen or keypad) and a display, which may be integrated with the UI to form a touchscreen display that is coupled with the processing system. In some examples, the wireless communication device 600 may further include one or more sensors such as, for example, one or more inertial sensors, accelerometers, temperature sensors, pressure sensors, or altitude sensors, that are coupled with the processing system.

The wireless communication device 600 includes an obtaining component 605, a setting component 610, an estimating component 615, a mapping component 620, and a providing component 625. Portions of one or more of the components 605, 610, 615, 620, and 625 may be implemented at least in part in hardware or firmware. For example, the components 605, 610, 615, 620, and 625 may be implemented at least in part by a processor or a modem. In some examples, portions of one or more of the components 605, 610, 615, 620, and 625 may be implemented at least in part by a processor and software in the form of processor-executable code stored in a memory.

### EXAMPLE CLAUSES

Implementation examples are described in the following numbered clauses:
Clause 1: A method performed at a SoC, including: obtaining parameters associated with estimated boot-up power consumption for different parts of the SoC; and setting at least one of operating voltages or operating frequencies for the different parts during a boot-up procedure, based on the corresponding parameters.
Clause 2: The method of Clause 1, where the parameters include at least one of open loop voltage or leakage current for the different parts.
Clause 3: The method of Clause 2, further including: estimating the boot-up power consumptions for the different parts based on the open loop voltages and the leakage currents obtained for the different parts.
Clause 4: The method of Clause 3, where setting at least one of operating voltages or operating frequencies for the different parts during a boot-up procedure includes: mapping the estimated boot-up power consumptions to values; and providing the values to a resource manager component that sets the operating voltages and operating frequencies for the different parts during the boot-up procedure.
Clause 5: The method of Clause 4, where the values correspond to regions, each region defined by a range of boot-up power consumption.
Clause 6: The method of Clause 5, where mapping the estimated boot-up power consumptions to values includes: for each different part, mapping the estimated boot-up power consumption for that part to one of the regions.
Clause 7: The method of Clause 5, where: each region has a corresponding vote value; and providing the values to the resource manager component includes providing the vote values to the resource manager component.
Clause 8: An apparatus, including: at least one memory including executable instructions; and at least one processor configured to execute the executable instructions and cause the apparatus to perform a method in accordance with any combination of Clauses 1-7.
Clause 9: An apparatus, including means for performing a method in accordance with any combination of Clauses 1-7.
Clause 10: A non-transitory computer-readable medium including executable instructions that, when executed by at least one processor of an apparatus, cause the apparatus to perform a method in accordance with any combination of Clauses 1-7.
Clause 11: A computer program product embodied on a computer-readable storage medium including code for performing a method in accordance with any combination of Clauses 1-7.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A method performed at a system-on-a-chip (SoC), comprising:
obtaining parameters associated with estimated boot-up power consumption for different parts of the SoC; and
setting at least one of operating voltages or operating frequencies for the different parts during a boot-up procedure, based on the corresponding parameters.

2. The method of claim 1, wherein the parameters comprise at least one of open loop voltage or leakage current for the different parts.

3. The method of claim 2, further comprising:
estimating the boot-up power consumptions for the different parts based on the open loop voltages and the leakage currents obtained for the different parts.

4. The method of claim 3, wherein setting at least one of operating voltages or operating frequencies for the different parts during a boot-up procedure comprises:
mapping the estimated boot-up power consumptions to values; and
providing the values to a resource manager component that sets the operating voltages and operating frequencies for the different parts during the boot-up procedure.

5. The method of claim 4, wherein the values correspond to regions, each region defined by a range of boot-up power consumption.

6. The method of claim 5, wherein mapping the estimated boot-up power consumptions to values comprises:
for each different part, mapping the estimated boot-up power consumption for that part to one of the regions.

7. The method of claim 5, wherein:
each region has a corresponding vote value; and
providing the values to the resource manager component comprises providing the vote values to the resource manager component.

8. An apparatus for wireless communication at a system-on-a-chip (SoC), comprising:
at least one memory comprising computer-executable instructions; and
one or more processors configured to execute the computer-executable instructions and cause the apparatus to:
obtain parameters associated with estimated boot-up power consumption for different parts of the SoC; and
set at least one of operating voltages or operating frequencies for the different parts during a boot-up procedure, based on the corresponding parameters.

9. The apparatus of claim 8, wherein the parameters comprise at least one of open loop voltage or leakage current for the different parts.

10. The apparatus of claim 9, wherein the one or more processors are further configured to cause the apparatus to:
estimate the boot-up power consumptions for the different parts based on the open loop voltages and the leakage currents obtained for the different parts.

11. The apparatus of claim 10, wherein, to set at least one of operating voltages or operating frequencies for the different parts during a boot-up procedure, the one or more processors are configured to execute the computer-executable instructions and cause the apparatus to:
map the estimated boot-up power consumptions to values; and
provide the values to a resource manager component that sets the operating voltages and operating frequencies for the different parts during the boot-up procedure.

12. The apparatus of claim 11, wherein the values correspond to regions, each region defined by a range of boot-up power consumption.

13. The apparatus of claim 12, wherein mapping the estimated boot-up power consumptions to values comprises: for each different part, mapping the estimated boot-up power consumption for that part to one of the regions.

14. The apparatus of claim 12, wherein each region has a corresponding vote value; and providing the values to the resource manager component comprises providing the vote values to the resource manager component.

15. An apparatus, comprising:
means for obtaining parameters associated with estimated boot-up power consumption for different parts of a system-on-a-chip (SoC); and
means for setting at least one of operating voltages or operating frequencies for the different parts during a boot-up procedure, based on the corresponding parameters.

16. The apparatus of claim 15, wherein the parameters comprise at least one of open loop voltage or leakage current for the different parts.

17. The apparatus of claim 16, further comprising:
means for estimating the boot-up power consumptions for the different parts based on the open loop voltages and the leakage currents obtained for the different parts.

18. The apparatus of claim 17, wherein means for setting at least one of operating voltages or operating frequencies for the different parts during a boot-up procedure comprises:
means for mapping the estimated boot-up power consumptions to values; and
means for providing the values to a resource manager component that sets the operating voltages and operating frequencies for the different parts during the boot-up procedure.

19. The apparatus of claim 18, wherein the values correspond to regions, each region defined by a range of boot-up power consumption.

20. The apparatus of claim 19, wherein means for mapping the estimated boot-up power consumptions to values comprises:
for each different part, means for mapping the estimated boot-up power consumption for that part to one of the regions.
